(19) United States
(12) Patent Application Publication
(10) Pub. No.: US 2012/0296512 A1
(43) Pub. Date: Nov. 22, 2012

(54) METHOD AND SYSTEM FOR ELECTRIC VEHICLE BATTERY PROGNOSTICS AND HEALTH MANAGEMENT

(75) Inventors: Jay Lee, Mason, OH (US); Seyed Mohammad Rezvanizaniani, Cincinnati, OH (US); Mohamed AbuAli, Cincinnati, OH (US); Yixiang Huang, Cincinnati, OH (US)

(73) Assignee: UNIVERSITY OF CINCINNATI, Cincinnati, OH (US)

(21) Appl. No.: 13/455,642

(22) Filed: Apr. 25, 2012

Related U.S. Application Data
(60) Provisional application No. 61/479,080, filed on Apr. 26, 2011.

(51) Int. Cl. G01M 17/00; B60L 11/18; G06F 17/00

(52) U.S. Cl. 701/29.3; 701/32.3; 701/32.1; 701/29.1; 701/33.4

(57) ABSTRACT

A system for managing mobility of an electrically-powered vehicle. The system includes a monitoring module comprising a plurality of sensors. Each of the plurality of sensors is configured to sense the status of at least one feature of each of the electrically-powered vehicle, an environment in which the electrically-powered vehicle is residing, and a state of health of a battery of the electrically-powered vehicle. A mobility analysis module estimates mobility of the electric-powered vehicle based on the sensed status, and a telematics module displays the sensed statuses, the estimated mobility, or both. The telematics module resides on a cloud-based server.

The present application claims the filing benefit of co-pending U.S. Provisional Patent Application No. 61/479,080, filed on Apr. 26, 2011, the disclosure of which is hereby incorporated by reference herein in its entirety.

### FIELD OF THE INVENTION

The present invention relates generally to vehicle power management systems and, more specifically, to electric vehicle power management systems as related to mobility.

### BACKGROUND OF THE INVENTION

Recent progress in rechargeable battery technologies, in combination with societal interests in decreasing greenhouse gas/carbon emissions, has accelerated innovations in electric vehicle (“EV”) and associated renewable energy storage devices, for example, batteries. Technological advances in reliability and dependability have been made, but there has not yet been much progress in the development of information systems that are configured to interact with these batteries.

Currently, there is very little information available from monitoring of batteries in addition to unmet need for the flow of information during phases of the battery life-cycle. That is, data and information acquired in one phase is not applied to other phases in order to achieve a complete analysis of the battery life-cycle.

The user's main concern when operating an EV is mobility rather than battery status, which is estimated using a Kalman filter or particle filter methods and is often reported as a State of Charge (“SOC”) or a State of Health (“SOH”). However, these reported states are only an indicator of the current health status of the battery. Because actual battery life is dynamic, in part due to actual load and individual usage, the current use of autoregressive moving average models and artificial neural network provide inaccurate results of remaining battery life and result in large deviations in the predicted battery life.

Thus, there remains a need to close the information flow loop such that useful information with respect to mobility and battery-life may be shared and utilized by EV users as well as by manufacturers, designers, and material suppliers for improving battery life management and accurately predicting mobility.

### SUMMARY OF THE INVENTION

The present invention overcomes the foregoing problems and other shortcomings and drawbacks of the prior art. While the present invention will be described in connection with certain embodiments, it will be understood that the present invention is not limited to these embodiments. To the contrary, this invention includes all alternatives, modifications, and equivalents as may be included within the scope of the present invention

According to one embodiment of the present invention, a system for managing mobility of an electrically-powered vehicle includes a monitoring module comprising a plurality of sensors. Each of the plurality of sensors is configured to sense the status of at least one feature from each of the electrically-powered vehicle, an environment in which the electrically-powered vehicle is residing, and a state of health of a battery of the electrically-powered vehicle. A mobility analysis module estimates mobility of the electric-powered vehicle based on the sensed statuses, and a telematics module displays the sensed status, the estimated mobility, or both. The telematics module resides on a cloud-based server.

Another embodiment of the present invention includes a method of managing mobility of an electrically-powered vehicle. The method includes monitoring use of the electrically-powered vehicle and estimating the mobility from the monitored use. The monitored use, the estimated mobility, or both are displayed.

These and other embodiments of the invention will be readily apparent from the following figures and detailed description of the present invention.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a diagrammatic view of a power management system configured to evaluate the mobility of an electrically-powered vehicle in accordance with one embodiment of the present invention.

FIG. 2 is a perspective view of an electrically-powered vehicle suitable for use with the system of FIG. 1.

FIG. 3 is a bottom view of the electrically-powered vehicle of FIG. 2.

FIG. 4 is a diagrammatic view of a controller for use in evaluating the mobility of the electrically-powered vehicle in accordance with one embodiment of the present invention.

FIG. 5 is a side-elevational view of a user console within the electrically-powered vehicle of FIG. 2 and incorporating a human machine interface for use with the system of FIG. 1.

FIG. 6 is a diagrammatic view of sub-systems comprising the power management system of FIG. 1.

FIG. 7 is a diagrammatic view illustrating details of the mobility management system depicted in FIG. 6 and in accordance with one embodiment of the present invention.

FIG. 8 is a diagrammatic view illustrating details of the remote monitoring system depicted in FIG. 6 and in accordance with one embodiment of the present invention.

FIG. 9 is a diagrammatic view illustrating details of the battery maintenance system depicted in FIG. 6 and in accordance with one embodiment of the present invention.

FIG. 10 is a diagrammatic view illustrating details of the suggestive service system depicted in FIG. 6 and in accordance with one embodiment of the present invention.

FIG. 11 is a diagrammatic view illustrating details of the intelligent analysis system depicted in FIG. 6 and in accordance with one embodiment of the present invention.

FIG. 12 is a flow chart illustrating a method of using the system of FIG. 1 in accordance with one embodiment of the present invention.

### DETAILED DESCRIPTION

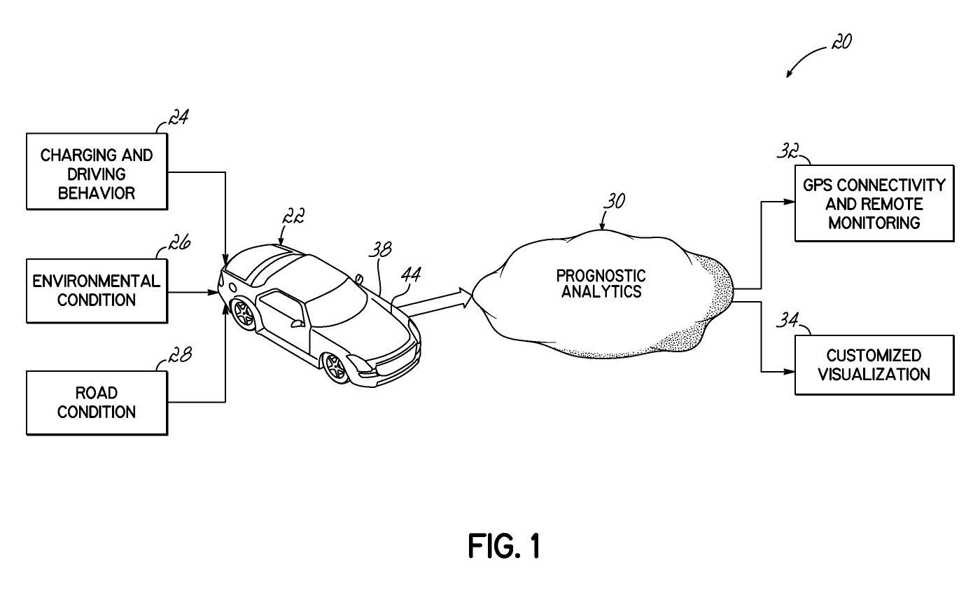

Turning now to the figures, and in particular to FIG. 1, a power management system 20 for evaluating the mobility of an electrically-powered vehicle (“EV” 22) is described in detail. The power management system 20 is configured to collect inputs from a variety of parameters with respect to the EV 22, including, for example, charging and/or driving behavior 24, environmental conditions 26, and road conditions 28 and processes those parameters with a prognostic analytics 30 such that one or more outputs are generated. These outputs may include, for example, Global Positioning System (“GPS”) connectivity and monitoring 32, customized visualizations 34 of power usage and terrain, and mobility, which are used herein as a measure of the distance, range, and/or time of operation for the EV 22.

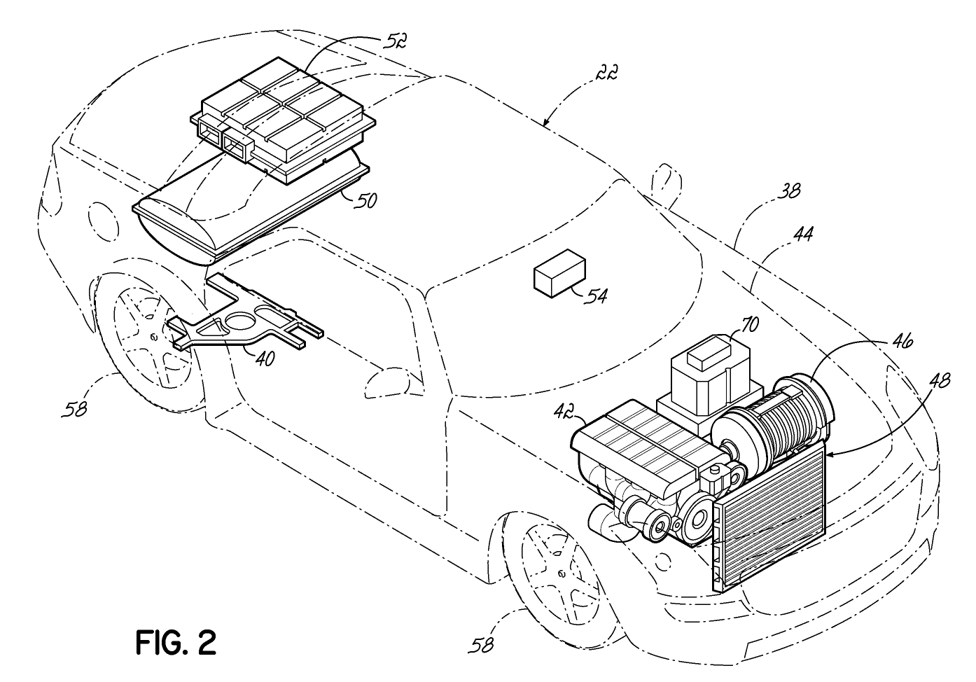

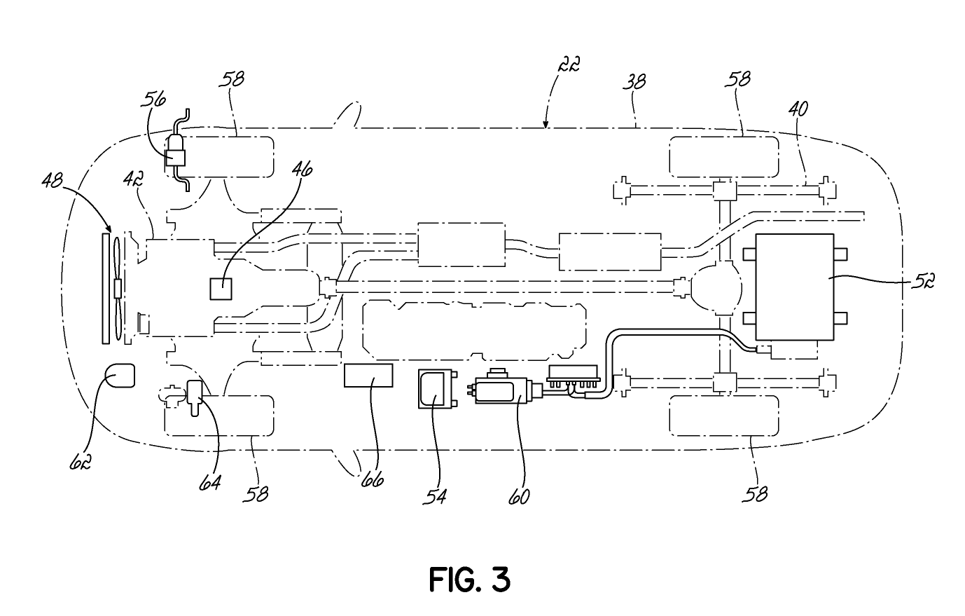

FIGS. 2 and 3 illustrate details of one hybrid EV 22 suitable for use with the present invention. The hybrid EV 22 includes a body 38 positioned on a chassis 40, which may be constructed of lightweight materials to reduce the overall weight of the EV 22. Though not necessarily assembled in the illustrated manner, the EV 22 will typically include an internal combustion engine 42 (illustrated as being beneath a front hood 44), an electric motor 46, and a radiator 48 to cool the engine 42 and/or electric motor 46. While a true EV requires no fuel, the hybrid EV 22 will further include a fuel storage tank 50 along with a battery 52. The battery 52 may be operably coupled to an external plug socket 56 via a charger 54 such that the hybrid EV 22 may be directly charged via the plug socket 56 and/or via regenerative braking, as is conventionally known. In use, the wheels 58 may be rotatively powered via the engine 42, the electric motor 46, or both.

While other configurations of EVs may be used, the exemplary hybrid EV 22 of FIGS. 2 and 3 is shown with some structural details for environment purposes. That is, the EV 22 may further include an inverter 60 to convert DC voltages to AC voltages, a steering pump 62 as part of the steering column, a clutch actuator 64 to convert operational force applied to a clutch to the engine 42, and a DC/DC converter 66 for adjusting the DC voltage. Other features and/or assemblies may be included and should not be considered to be limited to those particularly illustrated herein.

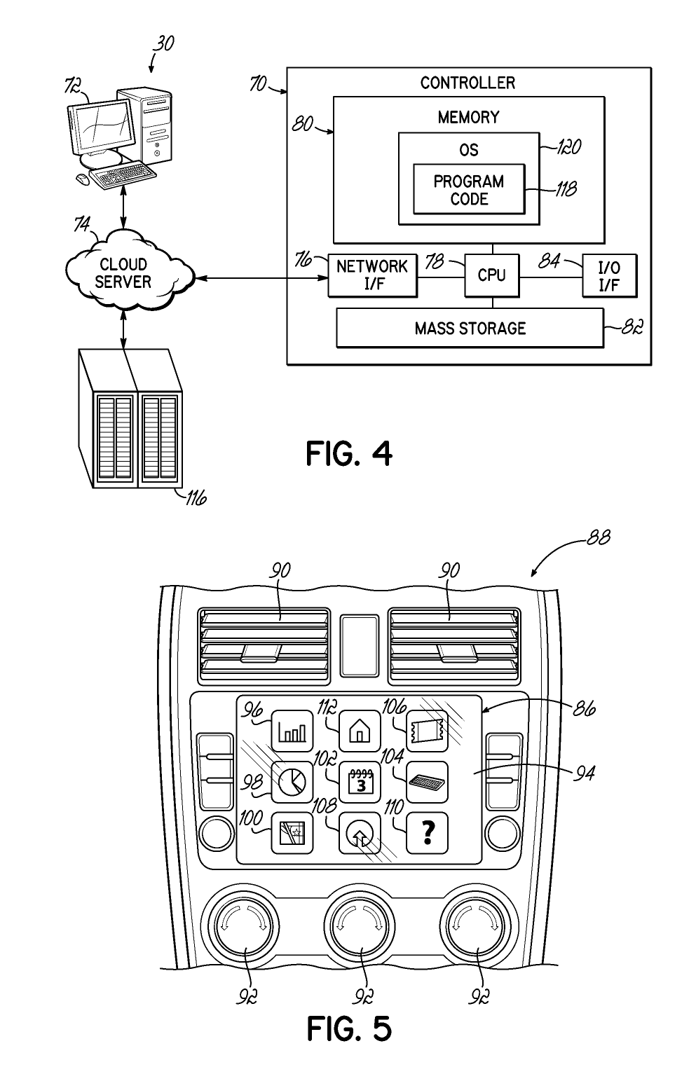

The EV 22 also includes a controller 70, one embodiment of which is shown and described with reference to FIG. 4. The controller 70 may be considered to represent any type of computer, computer system, computing system, server, disk array, or programmable device such as multi-user computers, single-user computers, handheld devices, networked devices, or embedded devices, etc. The controller 70 may also be referred to as a “computer” for brevity's sake, although it should be appreciated that the term “computing system” may also include other suitable programmable electronic devices consistent with embodiments of the present invention.

The controller 70 may be implemented with one or more networked computers 72 using one or more networks, e.g., in a cluster, a distributed computing system, or a cloud server 74 in which one or more cloud-based computing services are provided, through a network interface (illustrated as “NETWORK I/F” 76). The controller 70 may also be networked via satellite systems, such as a GPS (not shown) or other wired or wireless connection.

The controller 70 typically includes at least one processing unit (illustrated as “CPU” 78) coupled to a memory 80 along with several different types of peripheral devices, e.g., a mass storage device 82 having one or more databases (not shown), an input/output interface (illustrated as “I/O I/F” 84), and the Network I/F 76.

The I/O I/F 84 may further comprise a customized, user-friendly human machine interface (“HMI” 86), one embodiment of which is shown in FIG. 5. The HMI 86 may be incorporated into the user consol 88 within the EV 22 (FIG. 1), which conventionally includes air vents 90, climate control knobs 92, etc. The HMI 86, which is specifically shown herein as a touch screen LCD monitor 94, is configured to provide and receive information, as appropriate or desired, to and from the user (which may be the driver or a passenger). Such information may include details related to health and risk of the EV 22 (FIG. 1). The health and risk details may be presented in a visual display. Some exemplary displays may include visualization charts 96 indicating single battery performance monitoring, radar charts 98 for multiple battery performance monitoring or single battery fault diagnosis, and so forth. Other information may also be displayed, as determined by the user, such as maps 100, with or without GPS tracking, calendars 102, displayable keypad for data entry 104, searchable databases for entertainment 106, etc. The user may also interact with the cloud server 74 (FIG. 4), such as synchronization of data 108, open a help menu 110, or return to a home menu 112. Still other functions and operations may be incorporated into the HMI 86 and should not be limited to the particular illustrated features of FIG. 5. Alternatively still, the HMI may be incorporated into, or be operable with, an intelligence device (e.g., a tablet (for example, an iPad), a smart phone (iPhone®, Android®, Blackberry®), a laptop computer, or other like device) or a server (such as the cloud server 74 (FIG. 4)). The HMI according to these embodiments may include one or more apps 118 (FIG. 4) for interfacing with the controller 70.

With reference again to FIG. 4, the memory 80 of the controller 70 may include dynamic random access memory (“DRAM”), static random access memory (“SRAM”), non-volatile random access memory (“NVRAM”), persistent memory, flash memory, at least one hard disk drive, and/or another digital storage medium. The mass storage device 82 is typically at least one hard disk drive and may be located externally to the controller 70, such as in a separate enclosure or in one or more networked computers 72, one or more networked storage devices 116 (including, for example, a tape or optical drive), and/or one or more other networked devices (including, for example, the cloud server 74).

The CPU 78 may be, in various embodiments, a single-thread, multi-threaded, multi-core, and/or multi-element processing unit (not shown) as is well known in the art. In alternative embodiments, the controller 70 may include a plurality of processing units that may include single-thread processing units, multi-threaded processing units, multi-core processing units, multi-element processing units, and/or combinations thereof as is well known in the art. Similarly, the memory 80 may include one or more levels of data, instruction, and/or combination caches, with caches serving the individual processing unit or multiple processing units (not shown) as is well known in the art.

The memory 80 of the controller 70 may include one or more applications (illustrated as “Program Code” 118, or otherwise referred to as “apps”), or other software program, which are configured to execute in combination with the Operating System (illustrated as “OS” 120) and operating in accordance with one or more embodiments of the present invention, with or without accessing further information or data from the database(s) of the mass storage device 82 or via the cloud server 74.

Those skilled in the art will recognize that the environment illustrated in FIG. 4 is not intended to limit the present invention. Indeed, those skilled in the art will recognize that other alternative hardware and/or software environments may be used without departing from the scope of the invention.

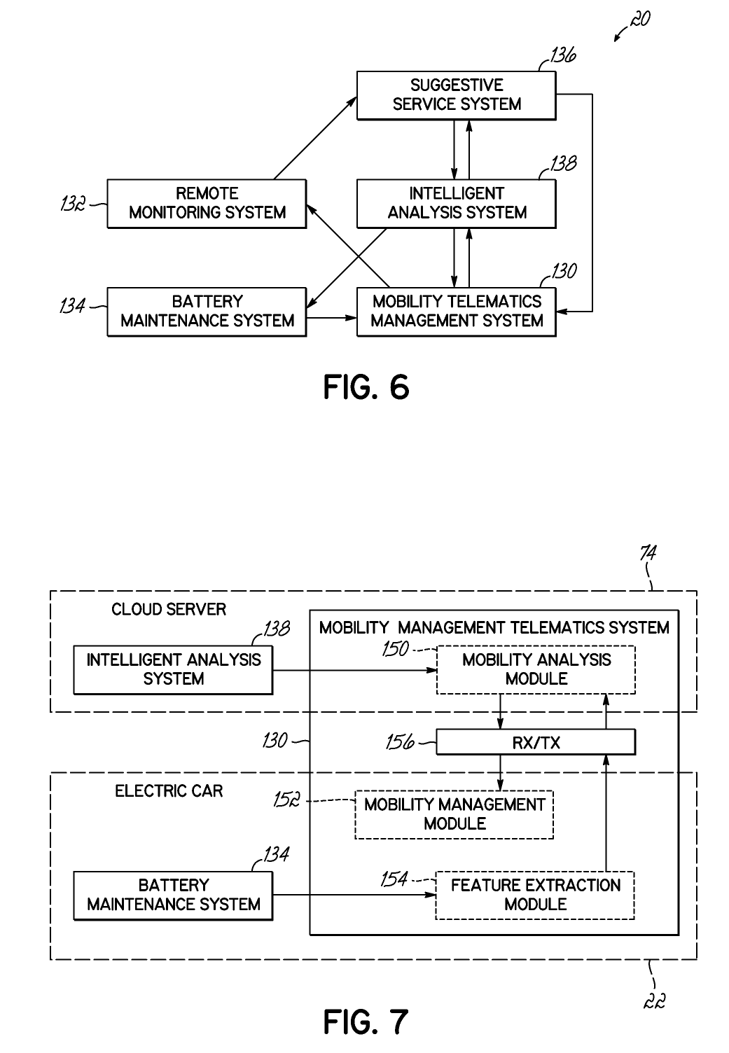

With reference now to FIG. 6, as well as continued reference to FIGS. 1 and 2, the prognostic analytics 30 associated with the power management system 20, in conjunction with the controller 70 and the cloud server 74, may be used in accordance with one embodiment of the present invention to determine the health and performance of the battery 52, diagnose the root-cause of a particular problem associated with the battery 52, estimate the remaining usefulness of the battery 52, and/or predict future risks or problems as a result of user-specific habits. In that regard, the power management system 20 includes a plurality of sub-systems (referenced herein as “systems” 130, 132, 134, 136), spanning the controller 70 of the EV 22, the cloud server 74, and/or other networked computers 72 and/or devices 116, as necessary, to effectuate the prognostic analytics 30.

In that regard, and with reference now to FIGS. 6 and 7, a mobility management telematics system 130 of the power management system 20 is described and is generally configured to receive, transmit, and display mobility information and/or otherwise interact with authorized users via the cloud server 74. More particularly, the mobility management telematics system 130 includes a cloud-based mobility analysis module 150, a mobility management module 152, a feature extraction module 154, and a data receiving and transmitting module (illustrated as “Rx/Tx” 156).

The mobility management module 150 is configured to interface and manage information flow between the cloud server 74, remote users (not shown), the EV 22, and the user via the HMI 86 (FIG. 5). A feature extraction module 154 is configured to receive signals representing sensory information with respect to the battery and EV components from the battery maintenance system 134, encodes, and transforms those signals into a format suitable for use by the mobility analysis module 150, and delivers the encoded and process data to the mobility analysis module 150. The mobility analysis module 150 also receives data from the intelligent analysis system 138, as described in detail below, and, with the data from the feature extraction module 154, analyzes and predicts a mobility of the EV 22.

Although not specifically shown, the mobility analysis module 150 may further comprise a storage module (not shown) that is configured to save data indicative of a position of the EV 22, such data operable to be displayed on a geographic information system (“GIS”). The results of the analysis by the mobility analysis module 150 may then be sent back to the HMI 86 (FIG. 5), for example, via a wireless network. While not required, it is preferred that the mobility analysis module 150 be configured to calculate and estimate mobility of the EV 22 in real time.

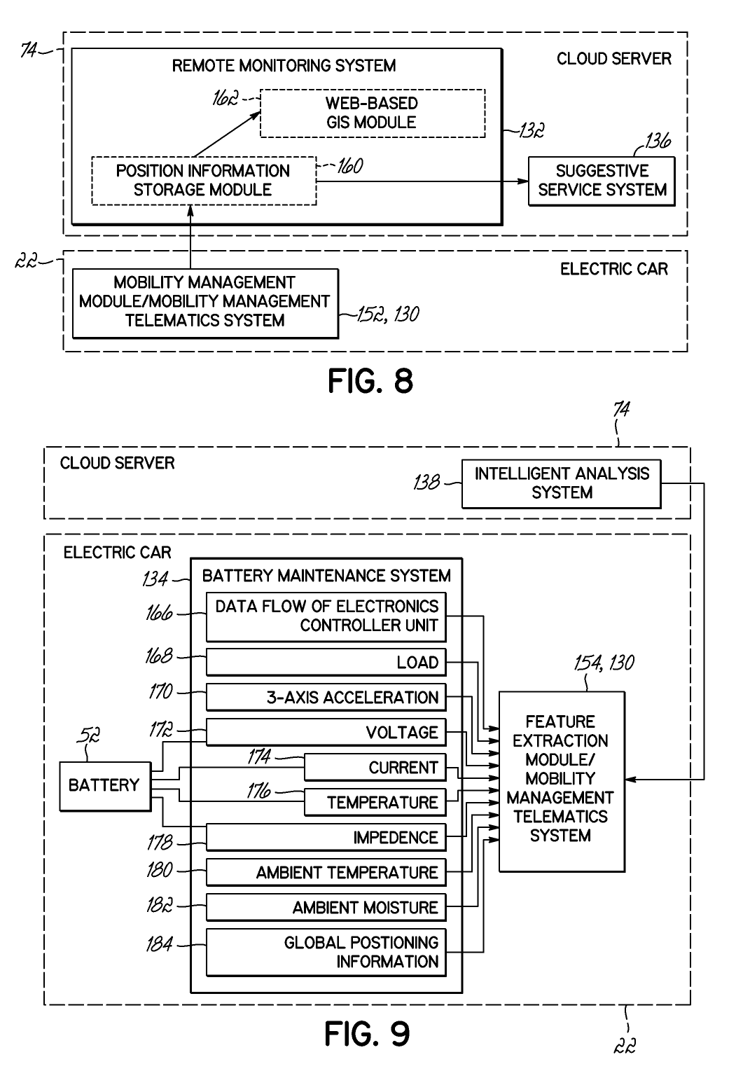

With reference now to FIG. 8, a remote monitoring system 132 is described in greater detail with respect to one embodiment of the present invention and may include a position information module 160 and a GSI module 162. Generally, the remote monitoring system 132 is configured to determine, store, and interactively display data with respect to the EV 22. More specifically, the position information storage module 160 receives and stores data with respect to the global position of the EV 22 and transmits the global position to web-based GIS module 162 for interactively displaying information for the user. The suggestive service system 136 may also receive global position data for us in the manner described in greater detail below.

Turning now to FIG. 9, the details of a battery maintenance system 134 in accordance with one embodiment of the present invention are shown. The battery maintenance system 134 includes a plurality of modules 166, 168, 170, 172, 174, 176, 178, 180, 182, 194, each operably coupled to a sensor associated with the EV 22. Each sensor evaluates, or receives, a signal representative of a functioning component of the EV 22. Thus, a portion of the modules may be configured to evaluate a bias voltage (module 172), an electrical current (module 174), a temperature (module 176), or an electrochemical impedance (module 178) with respect to the status and performance of the EV battery 52. Other modules receive sensory information with respect to the environment in which the EV 22 is being operated (for example, an ambient temperature (module 180), an ambient moisture (module 182), and global positioning (module 184)). Still other modules may be directed to the EV's overall function and use, including data flow (module 166), load (module 168), and three-axis acceleration (module 170). Each module may be operably coupled to an electric control unit (“ECU”), which is configured to record and compile the generated signals as user driving behavior.

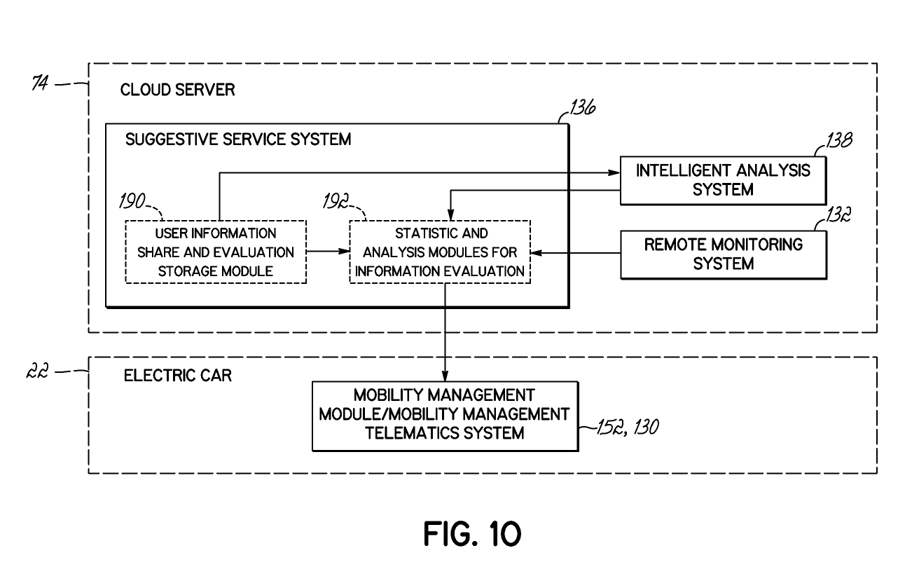

Details of a suggestive services system 136 according to one embodiment of the present invention are provided with reference to FIG. 10. The suggestive service system 136, which is operably coupled to the intelligent analysis system 138, is configured to suggest vehicular service and maintenance schedules based on user driving behavior. In accordance with one embodiment, the suggestive service system 136 may provide a schedule for charging the battery 52 or provide information with respect to the locations of charging stations during extended travel destinations. The suggestive services system 136 includes a user information share and evaluation storage module 190 that is configured to store data received from networked EVs and various users of EVs. The compiled data from the various users of EVs may then be recalled for use in calculating and estimating a driving range and/or mobility of a particular EV based, in part, on the collective experiences of the EV users.

The suggestive service systems 136 may also be configured such that users may share experiences with respect to EV function and performance, lifestyle and entertainment (for example, ratings of hotels, restaurants, charging stations, etc.), or travel and route (frequency of use, construction, etc.).

A statistic and analysis module 192 may include various statistical, analysis, models, and evaluation modalities for calculating and estimating the driving range and/or mobility. For example, signal processing may include one or more of a time domain analysis, a frequency domain analysis, a time-frequency analysis, a wavelet packet analysis, and a Principal Component Analysis (“PCA”); performance prediction may include one or more of AutoRegressive Moving Average (“ARMA”), Elman recurrent neural network, fuzzy logic, and match matrix; health assessment may include one or more of logistic regression, statistical pattern recognition, feature map pattern matching (self-organizing maps), neural networks, and Gaussian Mixture Models (“GMM”); and health diagnosis may include one or more of a Support Vector Machine (“SVM”), feature map pattern matching (self-organizing maps), Bayesian Belief Network (“BBN”), and Hidden Marker Models (“HMM”). Use of the suggestive service system 136 is described with greater detail below.

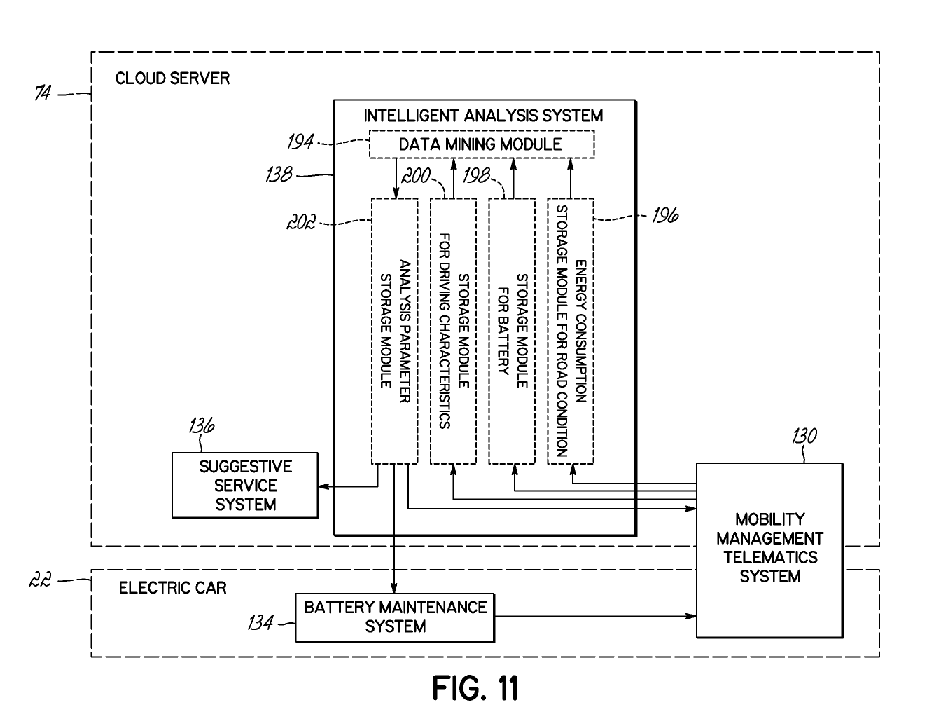

FIG. 11 illustrates an intelligent analysis system 138 according to one embodiment of the present invention and that is configured to analyze the signals received from the Rx/Tx 156 of the mobility management telematics system 130 with the user information, statistics, and analyses methods from the suggestive service system 136. In that regard, the intelligent analysis system 138 includes a data mining module 194 that receives data from an energy consumption storage module data based on road conditions (including, for example, whether the surface is wet or dry; smooth or rough; inclined, flat, or declined; the elevation, and so forth) 196 data, a storage module for the battery data 198, and a storage module for driving characteristics data 200 such that the data mining module 194 may learn the user's driving behavior via online learning algorithms. The data mining module 194 discovers patterns within and across the types of stored data, and to generate an analysis parameter that is transmitted to an analysis parameter storage module 202. The data mining module 194 obtains fusion information from a plurality of EV users and so as to build a database of information that may lead to more accurate model parameters. Continually updating the stored information within the database permits the most recent and complete evaluation by the data mining module 194 for all users. The analysis parameter may feed back into the battery maintenance system 134 for interaction with the EV 22 or into the suggestive service system 136 for use in evaluating and comparing driving characteristics, battery function, preferences, and so forth of other users.

Although not specifically shown, non-dynamic data may also be stored in one or more modules of the intelligent analysis system 138, such as an EV make and model, type or physical characteristics of the battery (such as lithium ion battery or nickel cadmium battery), physical characteristics of the EV make and model, manufacturer specifications of the battery, engine specifications, charger specifications, and so forth.

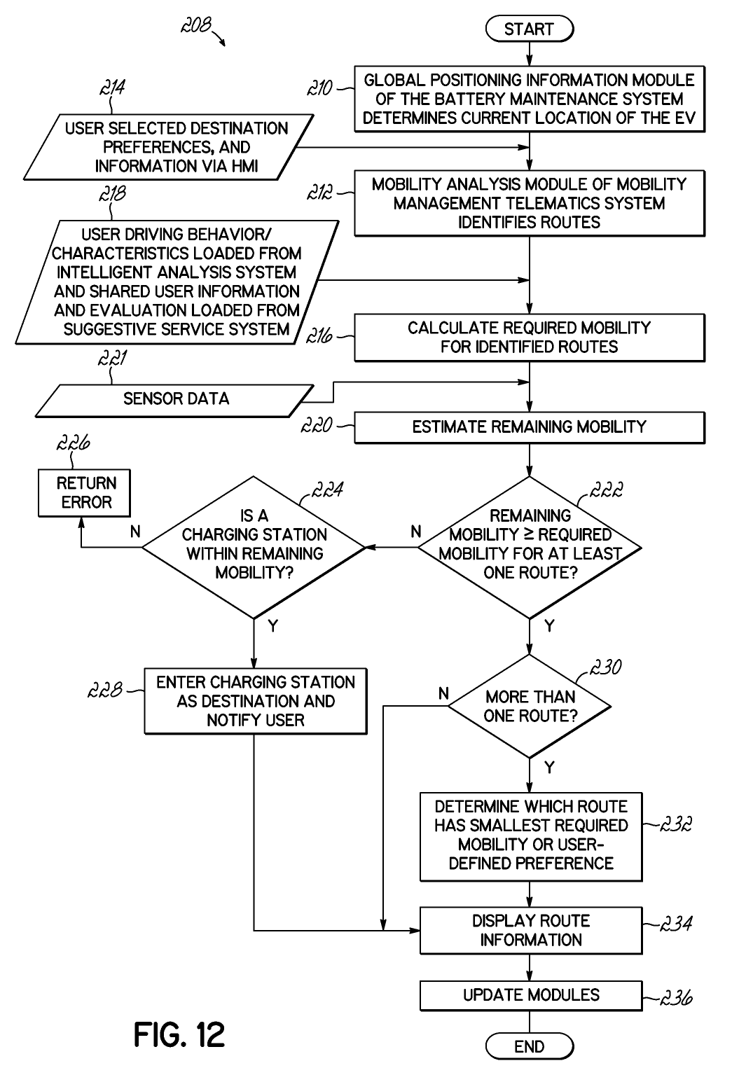

With the detail of the power management system 20 described according to one embodiment and with reference to FIG. 12, a flow chart 208 illustrating a method of using the power management system 22 (FIG. 1) to determine the mobility of the EV 22 (FIG. 1) is described in detail with respect to a destination or other user input and in accordance with one embodiment of the present invention. Before or after starting the EV 22 (FIG. 1), the global positioning information module 184 (FIG. 9) of the battery maintenance system 134 determines the current location of the EV 22 (FIG. 1) (Block 210). The location may be determined using one more of a global positioning system, cellular-phone towers, or other global information mapping system.

At some point, the user selects a destination, a preference, or otherwise provides information to the power management system 20 (FIG. 1) via the HMI 86 (FIG. 5) (Block 214). In this way, the power management system 20 may provide direction-driven services or content-driven services. Direction-driven services improve the estimation of mobility to direct the user to the selected destination via the route that utilizes the least battery life while content-driven services utilize mobility to direct the user to the nearest, selected or desired content provider (entertainment, food services, lodging, etc.) while using the least battery life. For example, and with brief reference again to FIG. 5, the user may select a location such as by selecting maps 100, entering an address via the keyboard 104, select a destination from the database of entertainment 106, including hotels, restaurants, and entertainment establishments, or from a listing of favorite locations and destinations. Other information input by the user may include a desired time of arrival, preferred route (for example, highway versus side streets), and so forth.

With such information now input, the mobility analysis module 150 (FIG. 7) of the mobility management telematics system 130 (FIG. 7) may identify at least one route from a current location of the EV to the selected destination (Block 212). Although not shown, the one or more routes may be determined in accordance with certain predetermined criteria, including, for example, length of route, traffic patterns, traffic incident reports, and so forth. Conventional determinations of routes are improved by incorporating the estimated mobility, which is determined in accordance with one embodiment of the present invention and as described herein.

The identified routes (Block 212) with other information inputs (Block 218), such user behavior characteristics (loaded from the intelligent analysis system 138) and shared user information (loaded from the suggestive service system 136) may be provided to the mobility analysis module 150, with the necessary and appropriate statistics and analysis tools (loaded from the suggestive service system 136) to determine a required mobility for each of the identified routes (Block 216). In other words, the identified routes will generally vary in distance, terrain, traffic (highway versus city street), etc., which affects a level of mobility necessary to reach the destination via that route. Because remaining battery power is a dynamic parameter, varying routing decisions, multiple measures, internal as well as external, are necessary to fully evaluate, in real time, remaining battery power and mobility. In fact, a selected route will be considered as a regime with specific parameters that influence the battery's state of charge; therefore an appropriate intelligent classification tool is required to recognize the regime of operation and then predict the battery remaining power and mobility. For instance, a route having more and/or steeper hills as compared to another route will require a larger mobility to complete that route. Furthermore, whether the EV is carrying one person or a plurality, with or without luggage, the current, voltage, temperature of the battery will change over time and affects the health of the battery and eventually, the battery life cycle, as well as mobility.

With the EV in motion, the sensor modules 166-184 of the battery maintenance system 134 may generate signals (Block 221) representing the internal and external measures. Real time measurements may include, apart from those described previously, a condition of the road based on a set of acceleration signals, turn information, road bumps, and a three-axis acceleration sensor configured to detect vehicular vibration, and so forth.

Signals representing the internal and external measures are transmitted from the battery maintenance system 134 to the mobility analysis module 150 of the mobility management telematics system 130. The sensor signals, along with historic driving characteristics (user decision/preferences, frequency of brake use, applied braking forces, frequency of lane changes, and so forth from module 200), battery performance and maintenance (module 198), and energy consumption patterns (module 196), with or without other user information provided via the suggestive service system 136, are used in calculating an estimated remaining mobility of the EV (Block 220).

If the user has not previously designated as preference with respect to routes, the power management system 20 may then make an inquiry (Block 222) as to whether the remaining mobility of the EV 22 is greater than or equal to at least one of the identified routes. In that regard, improved estimates of mobility, as determined in accordance with embodiments of the present invention, in turn improve the accuracy of this determination. Accordingly, and if the determination is that EV 22 lacks the mobility to arrive at the selected destination (“No” branch of decision block 222), then the power management system 20 may determine whether a battery charging (or changing) station exists within the remaining mobility (Block 224). In that regard, the EV 22 may determine the location providing battery services within the geographical area attainable by the mobility and show the driver the closest battery surface locations. If the remaining mobility is such that it is not likely the EV 22 could arrive at the destination or a charging/changing station (“No” branch of decision block 224), then an error may be returned to the user (Block 226), for example, “Change battery pack.” Otherwise, (“Yes” branch of decision block 224), the power management system 20 may enter the charging/changing station as the destination and notify the user that the selected destination has been overridden (Block 228). Although not shown, the user may be presented with an option of overriding the change in selected destination or other alternative response.

Returning again to the inquiry as to whether remaining mobility is sufficient for at least one route (Block 222) and if there is at least one suitable route (“Yes” branch of decision block 230), then a route is selected. Selection of the route may depend on various factors, including which route has smallest required mobility or is in accordance with a user-defined preference (Block 232), such as is shown according to the present embodiment. Still other factors may be considered, including, user driving habits, battery maintenance service, route optimization service, charging schedule service, driving behavior analysis service, and power-oriented route optimization path suggestion services.

Once determined, the power management system 20 may display the route information, such as a turn-by-turn description or on a map (Block 234). Otherwise, and if only one route was appropriate (“No” branch of decision block 230), the one route is selected and the route information displays (Block 234). The power management system 20 may then update the stored information (Block 236), such as those storage modules 196, 198, 200 of the intelligent analysis system 138 for future use and/or transmitting information to the user information share and evaluation storage module 190 of the suggestive service system 136 for use by EV users, at large.

As provided in detail herein, a cloud-based, mobility management system configured to provide dynamic mobility management service, for use and exchange by those of the EV user community is described. The enabling features of the present invention include the flexible instrumentation of the battery; the prognostic analytics capabilities; and the customized visualizations. The flexible instrumentation enables online data acquisition from the field and the automated testing procedures for fast acquisition of battery data in a variety of operating regimes. Additionally, battery observational data are captured by sensory devices under each operating regime. The prognostic analytics capabilities digest the large amount of data and convert it to useful health and risk information representing the state of health and performance of the battery, the diagnostic information of the root-cause of the problems, remaining-useful life of the battery, and battery risk based on different user specified performance criteria.

While the present invention has been illustrated by description of various embodiments and while those embodiments have been described in considerable detail, those skilled in the art will readily appreciate that many modifications are possible in the exemplary embodiments without materially departing from the novel teachings and advantages of this invention. The invention in its broader aspects is therefore not limited to the specific details and illustrative examples shown and described. Accordingly, departures may be made from such details without departing from the scope of the present invention.

What is claimed is:

1. A system for managing mobility of an electrically-powered vehicle comprising:
a monitoring module residing on the electrically-powered vehicle and including a plurality of sensors configured to sense the status of at least one feature from each of the electrically-powered vehicle, an environment in which the electrically-powered vehicle is residing, and a state of health of a battery of the electrically-powered vehicle;
a mobility analysis module configured to estimate mobility of the electric-powered vehicle based on the sensed statuses; and
a telematics module residing on a cloud-based server and configured to display the sensed statuses, the estimated mobility, or both.

2. The system of claim 1, further comprising:
a data receiving module residing on the cloud-based server and configured to receive the sensed statuses; and
a transmitting module residing on the cloud-based server and configured to transmit the estimated mobility to a human machine interface.

3. The system of claim 2, wherein the human machine interface resides on at least one of the electrically-powered vehicle and a personal communication device.

4. The system of claim 1, further comprising:
a user interface configured to display the sensed status, the estimated mobility, or both.

5. The system of claim 4, wherein the user interface includes at least one of:
a sensor connection module configured for displaying the sensed statuses;
a data buffer module configured for storing the sensed statuses;
a data encoding module configured to encode and organize the sensed statuses according to a data protocol;
a data receiving module for receiving the estimated mobility;
a data sending module configured to send the sensed statuses to the mobility analysis module; and
an interface module operable as an input and output interface.

6. The system of claim 1, wherein the mobility analysis module includes a feature extraction analysis module configured to extract data representative of at least one feature of the electrically-powered vehicle, the environment, and the state of health of the battery from the sensed statuses, and a feature storage module configured to store the extracted data.

7. The system of claim 1, wherein the telematics module includes a web-based geographic information system module configured to display one or more of the mobility, a location, a velocity, an acceleration, and the state of health of the battery on a web-based map.

8. The system of claim 1, wherein the sensed statuses of the plurality of sensors includes a battery voltage, a battery current, a battery temperature, an ambient temperature, an ambient humidity, a three-axis acceleration, or two or more thereof.

9. The system of claim 1, wherein the mobility analysis module includes a data mining module configured to discover one or more patterns in the sensed statuses.

10. The system of claim 9, further comprising:
a suggestive service system configured to receive and store sensed statuses from a plurality of electrically-powered vehicles, wherein the one or more patterns discovered by the data mining module further includes patterns discovered in the stored, sensed statuses of the suggestive service system.

11. The system of claim 10, where the suggestive service system is further configured to provide a vehicular service suggestion, a schedule of maintenance, or both, based on the one or more patterns.

12. A method of managing mobility of an electrically-powered vehicle comprising:
monitoring use of the electrically-powered vehicle;
estimating the mobility of the electrically-powered vehicle from the monitored use; and
displaying at least one of the monitored use and the estimated mobility.

13. The method of claim 12, wherein monitoring use includes a sensing a status of at least one feature of each of the electrically-powered vehicle, an environment in which the electrically-powered vehicle is residing, and a state of health of a battery of the electrically-powered vehicle.

14. The method of claim 13, further comprising:
extracting, organizing, and encoding the sensed statuses according to a data protocol; and
transmitting the encoded and sensed statuses to a mobility analysis module residing on a cloud-based server.

15. The method of claim 12, further comprising:
recalling, from a stored memory, at least one of driving characteristic data of a prior use of the electrically-powered vehicle, energy consumption data during a prior use of the electrically-powered vehicle, and battery data from a prior use of the electrically-powered vehicle,
wherein estimating the mobility further includes recalling at least one of the driving characteristic data, the energy consumption data, and the battery data.

16. The method of claim 12, further comprising:
receiving monitored use from a plurality of electrically-powered vehicles,
wherein estimating the mobility further includes receiving monitored use from a plurality of electrically-powered vehicles.

17. The method of claim 12, further comprising:
saving the monitored use as a prior use.

18. The method of claim 12, further comprising:
determining a route and a required mobility for driving the route;
comparing the estimated mobility to the required mobility; and
based on the comparing, providing directions for the route or suggesting a maintenance service.

19. The method of claim 12, wherein monitoring use includes sensing a battery voltage, a battery current, a battery temperature, an ambient temperature, an ambient humidity, a three-axis acceleration, or two or more thereof.

20. The method of claim 12, further comprising:
discovering one or more patterns in the monitored use; and
providing a vehicular service suggestion, a schedule of maintenance, or both based on the discovered one or more patterns.
